(19) United States
(12) Patent Application Publication
(10) Pub. No.: US 2022/0108292 A1
(43) Pub. Date: Apr. 7, 2022

(54) PAY BY TEXT SYSTEMS AND METHODS

(71) Applicant: Amici Inc., Saint Paul, MN (US)

(72) Inventors: Mitchell James Terrell, Minneapolis, MN (US); Benjamin James Bowman, Saint Paul, MN (US)

(21) Appl. No.: 17/492,540

(22) Filed: Oct. 1, 2021

Related U.S. Application Data
(60) Provisional application No. 63/087,152, filed on Oct. 2, 2020.

(51) Int. Cl. G06Q 20/14; G06Q 20/32; G06Q 40/02; G06Q 30/04; G06Q 20/40; G06K 9/00

(52) U.S. Cl. CPC G06Q 20/14; G06Q 20/326; G06Q 40/02; G06K 9/00449; G06Q 20/4014; G06Q 20/3255; G06Q 30/04

(57) ABSTRACT

A system and method for paying bills is disclosed that includes a bill from a payee. The bill includes text payee information that includes a due date, an account number, identification of the payee, an amount due, and payer information. The disclosed system also includes a statement disposed upon the paper bill that includes instructions for a payer to retrieve or take a photo of the bill and to send the picture to a billing text number on the statement. The bill can include one or more images and text. The one or more images can be processed by an image interpretive object and the text payee information can be processed by optical character recognition software for determining payment options that are the most likely to be paid, and the best prediction that the payee will receive payment due.

### CROSS REFERENCE TO OTHER APPLICATIONS

The current disclosure claims priority to U.S. Provisional Application No. 63/087,152, filed Oct. 2, 2020 with the title “Pay by Text Systems and Methods.”

### FIELD OF THE INVENTION

This disclosure relates systems and methods for paying paper bills. More particularly, this disclosure relates to but is not limited to the payment of paper medical bills.

### BACKGROUND

Many goods and services are still billed to the customer on paper. There are many difficult and inconsistent methods for paying off these paper bills. When a customer receives a paper bill in the mail, for example a medical bill, each bill has a different set of instructions to follow to pay off all or part of the amount due to the biller. Sometimes the paper bills can be paid by mailing in a check. Or, a tear-off sheet on the paper bill can be separated from the bill and sent in with credit card information on it for payment. Finally, it may be necessary, in some circumstances, to log in to another online account to pay the paper bill.

There is often not a simple way to get paper bills paid without logging into a multitude of online accounts and plugging payment information (for example, credit card or debit card information) into a non-secure online platform. Additionally, there is no easy way to provide payment installation methods in paying for goods or services. There are applications such as SEZZLE that, with membership, allow customers to have purchases broken down into simple, interest-free installments—most commonly, for example, four equal payments each two weeks apart.

### SUMMARY

The disclosed systems and methods allow a customer to pay paper bills faster and in a secure fashion. Additionally, the disclosed systems and methods help the payees (frequently medical corporations or businesses) to get faster payment from customers. Finally, the disclosed systems and methods allow customers to be billed by the systems in installments in order to make paying bills manageable to the customer. Additionally, installment paying can help increase the liquidity of the payees.

In one aspect, a system for paying paper bills is disclosed that includes a paper bill from a payee. The paper bill includes text payee information that includes a due date, an account number, identification of the payee, an amount due, and payer information. The disclosed system also includes a statement disposed upon the paper bill that includes instructions for a payer to take a text picture of the paper bill and to send the text picture to a billing text number on the statement. The text picture of the paper bill can include one or more images and text.

The one or more images can be processed by an image interpretive object and the text payee information can be processed by optical character recognition software.

In another aspect, a method of paying paper bills is disclosed that can include paying paper bills and a payee sending a paper bill to a payer. The paper bill can include text payee information that can include a due date, an account number, identification of the payee, an amount due, and payer information. A statement that has instructions to the payer can be disposed upon the paper bill. The disclosed method can further include the payer taking a text picture of the paper bill and sending the text picture of the paper bill to a billing text number disposed upon the paper bill. The text picture of the paper bill can include one or more images and text. The one or more images can be processed by an image interpretive object, and wherein the text payee information is processed by optical character recognition software.

In this application,

“payee” refers to a company, individual, or other entity that has offered a service or a product and expects reimbursement; and

“payer” or “payor” can be used interchangeably with “customer” or “client” or “user” and refers to a different entity that receives a bill from the payee and proceeds to pay at least a portion of the amount owed to the payee for the service or product rendered by the payee.

The systems and methods presented herein can allow a customer (or payer) to pay paper bills faster and in a secure fashion. Additionally, the disclosed systems and methods can help the payees (frequently medical corporations or businesses) to get faster payment from customers. Finally, the disclosed systems and methods allow customers to be billed by the systems in installments in order to make paying bills manageable to the customer. Additionally, installment paying can help increase the liquidity of the payees.

### BRIEF DESCRIPTION OF THE DRAWINGS

The following description should be read with reference to the drawings. The drawings, which are not necessarily to scale, depict examples and are not intended to limit the scope of the disclosure. The disclosure may be more completely understood in consideration of the following description and with respect to various examples in connection with the accompanying drawings, in which:

FIG. 1 is a representation of a bill displayed on a graphical user interface of a computing device, according to an embodiment of the disclosed system and method;

FIGS. 2 and 3 are schematic diagrams of a portion of an embodiment that illustrates the structure of the disclosed system and method;

FIG. 4 is a schematic diagram of a portion of an embodiment of the disclosed system and method in which the text image is interpreted;

FIG. 5 is a schematic diagram of a portion of an embodiment of the disclosed system and method that how the text is continuously processed and reprocessed until a threshold score is attained;

FIG. 6 is a schematic diagram of a portion of an embodiment of the disclosed system and method that illustrates the interaction of the image interpretation object with the SQL server and the system text server;

FIG. 7 is a schematic diagram of a portion of an embodiment of the disclosed system and method that illustrates the interaction of the system text server with the payer and payment options offered to the payer;

FIG. 8 is a schematic diagram of a portion of an embodiment of the disclosed system and method that illustrates the information flow between the payee and the system text server;

FIG. 9 is a schematic diagram of a portion of an embodiment of the disclosed system and method that illustrates the dialog flow between the payee, payer, and system text server;

FIG. 10 is a schematic diagram of an overall view of an embodiment of the disclosed system and method; and

### DETAILED DESCRIPTION

Various embodiments are described in detail with reference to the drawings, in which like reference numerals may be used to represent like parts and assemblies throughout the several views. Reference to various embodiments does not limit the scope of the systems and methods disclosed herein. Examples of construction, dimensions, and materials may be illustrated for the various elements, and those skilled in the art will recognize that many of the examples provided have suitable alternatives that may be utilized. Any examples set forth in this specification are not intended to be limiting and merely set forth some of the many possible embodiments for the systems and methods. In one embodiment, a paper bill may be reference, but it is understood that electronic bills and other types of bills are within the scope of this invention. It is understood that various omissions and substitutions of equivalents are contemplated as circumstances may suggest or render expedient, but these are intended to cover applications or embodiments without departing from the spirit or scope of the disclosure. Also, it is to be understood that the phraseology and terminology used herein are for the purpose of description and should not be regarded as limiting.

Various modifications and alterations to this disclosure will become apparent to those skilled in the art without departing from the scope and spirit of this disclosure. It should be understood that this disclosure is not intended to be unduly limited by the illustrative embodiments set forth herein and that such embodiments are presented by way of example only with the scope of the disclosure intended to be limited only by the claims set forth herein as follows. All references cited in this disclosure are herein incorporated by reference in their entirety.

A system is disclosed for paying a paper bill that a payer can receive from a payee. The payee can be any entity that performs a service for or sells a product to a payer. In this disclosure the term payee can be a company, corporation, or individual to which the payer owes reimbursement for the service or product. The payer can include a client, a customer, a patient, or any other entity that owes reimbursement to the payee.

Typically, a paper bill from a payee can include information that can include identification of the payee, contact information such as address, phone number, e-mail address, or text address of the payee. The paper bill can also include an account number, an amount due and information from the payer such as name, address, e-mail or text number, or other identification information. The paper bill can also include a statement disposed upon it that includes instructions of how the payer can pay the bill. These instructions can include instructing the payer to text a picture (or image) of the paper bill to a text number included in the instructions. Additionally, the instructions can include other information such as how the payer wants to pay the bill. Typically, the paper bill suggests an electronic payment system or platform such as, but not limited to, PAY PAL, APPLE PAY, GOOGLE PAY, VENMO, ZELLE, CASH APP that the payer can use to pay the bill.

Once the payer sends (texts) an image to the text number on the paper bill, the image is filtered down by cropping, gray scale, Gaussian blur, etc. to obtain an image that can be easily and accurately read. The image goes through pre-processing steps to ensure that the image is in optimal form to run through Optical Character Recognition (OCR). The OCR attempts to try to detect what is written on the bill. This includes payment number, amount paid, and information about the payer.

The disclosed system then responds to the payer to confirm the payment amount that needs to be paid, asks for the preferred method of payment desired by the payer, and provides at least one payment types, which may include, but are not limited to, direct banking withdrawal, electronic payment options, credit card information, and an option for the payer to pay in installments. Depending upon the payment method selected (full amount or installment) the payer is electronically charged the payment amount via text or phone call using the electronic payment platform selected by the payer. If the payer has selected a payment plan (in one embodiment, an installment plan), the amount of an installment payment agreed upon is payed electronically by the payer using the disclosed system. The selection screen, may have a graphical interface where the user may select such payment method type. In one embodiment, the screen may include a list, drop down menu, electronic button or selection display that allows the user to indicate the payment type. Once payment type is selected, the transaction may continue.

The installment payment may be selectable based on the user having an account or prior verification to select installment option(s). In one embodiment, the system may verify at the user may enter into installments payments and allow access to the installment payment selection. In another embodiment, the system may verify ability to pay with installments after the installment payment type is selected, then the application will send a verification request to the system for database verification that the user associated with the account may pay with installment payments. The system may have stored data that allows the verification process to occur, such as signed agreements for agreeing to installment payment terms, etc. The system may then allow the installment payments for users of accounts that are pre-approved for paying with installments. In other embodiments, the user may have to verify approval with every transaction. The verification step may determine when the user is able to select installment payment type during a transaction.

Additionally, transactions completed with installment payments may cause the disclosed system to remind the payer before the next installment payment is due via an email, text message, notification, etc and will collect the next installment amount electronically using the same method used for the first payment unless the payer changes the choice of platforms. In some embodiments, the installment amount can be about 25% of the total amount, or even less depending upon the amount set up by the system. The user may have selected a predetermined about for installment payments. In other embodiments, the system may determine the installment payments based on the use of the system, credit, use with applications executed with a computing device, based on use of the application, etc. In some embodiments the installment about may be based on the total value of the transaction or the individual goods. The determined about may be stored in the system to determine future installment payments associated with the account of the user or for determining the payments of other users.

Once the disclosed system collects the installment payment, the value or amount is immediately credited to the payee, closing the loop and ending the transaction. The payee needs to be signed up to utilize the disclosed system so that payment from the payer to the disclosed system and from the disclosed system to the payer is seamless, electronic, and substantially instantaneous. The system then tracks the individual payments for associated with the original transaction, until the full payment is completed. Ability to pay the installment amount in full is stored in association with the user's account and stored in the system.

Embodiments of the disclosed system can be further understood by referencing the Figures included herein.

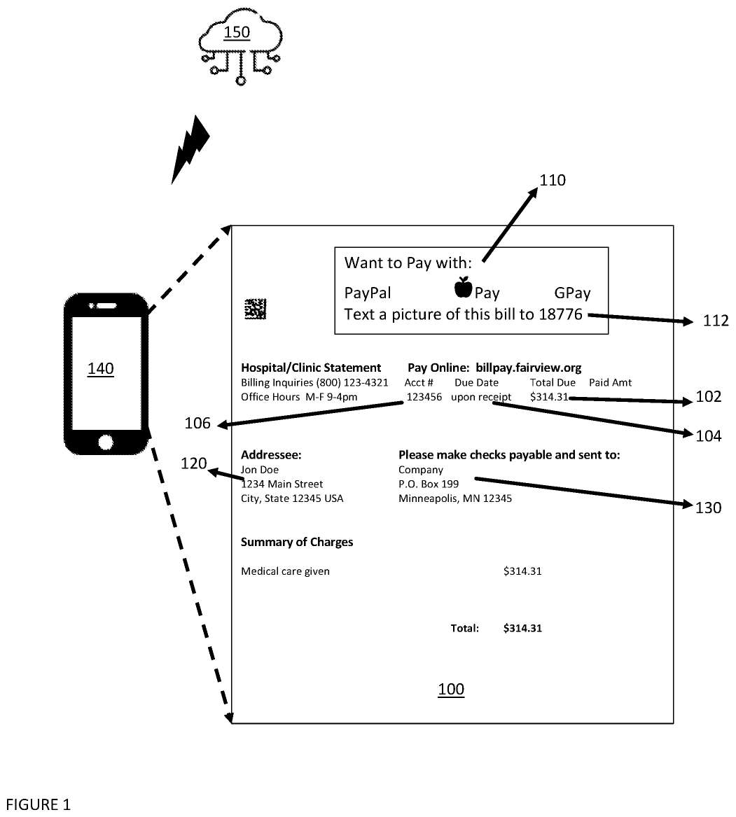

FIG. 1 is a representation of a bill 100 that is displayed at the graphical user interface (“GUI”) of a computing device 140, according to an embodiment of the disclosed system and method. The bill 100 may be a paper bill, and the computing device 140 may take a photo or a screen capture of bill 100. In the illustration of FIG. 1, bill 100 may be a photo of a medical bill from a medical payee. Bill 100 shown in FIG. 1 includes text payee information such as amount due 102, due date 104, and account number 106. Bill 100 also provides instructions for online payment through a bill pay host, such as an online bill pay website. Bill 100 also includes payment options on the statement (of bill 100). The instructions may be identified on bill 100, such as in pay instructions 100, or they may be sent in a text, email, notification, reminder, calendar entry, identifying payment instructions and how to pay bill 100. Other websites, QR codes, etc. may be associated with the bill to instruct the payor how to initiate a payment. In some embodiments, bill 100 may include pay instructions 112 instructing the payer to text a picture (image) 100 of the paper bill and send the picture to billing text number (“1234567” in FIG. 1). The text picture (of bill 100) can include one or more images and text. The text includes the address of the payer (“Jon Q Doe”) 120 and the identification of the payer 130.

In the embodiment of computing device 140 of FIG. 1, computing device 140 may include one or more storage devices within the computing device may store information required for use during operation of computing device 140 (e.g., image module(s), billing modules, object recognition modules, prediction modules, etc.) for determining at least one payment that the user (payor) would likely complete payment of to the payee. The application determines the most likely means for the payee to complete payment, increasing the success of the payee receiving payments and completing the fulfillment of the amount satisfying the payment. The application may look at predictions for in full payments or installments payments, or a variation to get the payor to pay the bill off or as close as possible to payment in full. In this disclosure, medical bills are used as a non-limiting embodiment, because many people are unable to make the payments by the deadline. However, other types of bills may be paid using the applications and determining the highest likelihood that the payor will pay in full or in the largest possible part of the bill to payee.

In this non-limiting embodiment, we look at when a user, they payor, uses an application on their computing device to take a photo of a paper bill to initiate execution of the application. Other way to initiate may include looking at a bill in email, online in the user's account, in a text message, in saved documents, or other applications or files on user's computing device 140. Once a photo is taken, the user may follow instructions noted on bill 100. In the illustration of FIG. 1, payment instructions 110 include an indication “Text a picture of this bill to 18776” 112, as instructions to pay the medical bill 100.

After the user executes a text application on computing device 140 for initiating payment, the user may select the photo, such as by uploading the photo previously taken or using the camera option through the executing text app to take the photo of bill 100. When computing device 140 sends the image of bill 100 to cloud 150, cloud 150 may determine if user has an account existing or has already agreed to terms and conditions. Computing device may receive from cloud 150, or may on it's own, display an indication for the user to agree to terms and conditions of use of the application. The terms and conditions may include agreeing to pay amount that are identified in payment options presented, and to timely make each and every payment (of the user's selected payment option) agreed to. Terms and conditions agreement may be input at the GUI and sent to cloud 150 for continuing the payment application process. In some embodiments, agreement of the terms may initiate determining payment options for bill 100.

The application may locally process the information or may sent bill 100 information data to a remote server in the system, such as clout computing 150. The lightning bolt represents transmission of data and communication across a network. Cloud 150 may receive bill 100 (or the digital capture of bill 100), which may automatically initiate determination of at least one payment option or computing device 140 may send a request to cloud 150 for determining a payment option. The remote server may then gather and analyze data for determining at least one payment option. The application uses object recognition to identify objects of bill 100, such as the amount due 102, due date 104, account number 106, address and addressee information, payee, and possibly other factors identified in bill 100 may also be analyzed. Even services or good that the bill was issued for or noted in bill 100. The server (cloud 150) may look at the history of the user (payor) has in paying bills with the application, or payment information with other applications on computing device 140. Other information used, may include other payment or bill information of other system users, including success of payment of each respective user to each respective payee. Payment amount may be used to determine a larger or small amount predicting if the user will pay. The frequency of payments of the user or other users that had the greatest success for payments received may also be considered. The other information from the computing device, such as bank information and credit card debt may also be considerations predicting if the user will likely pay the payment(s) as they come due. Payment frequency from a job or revenue source may determine frequency of payment.

In one embodiment, the application may determine if the user (payor) will likely pay the amount due or if the user is more likely to pay more than one installment payment. The application may determine prediction and likelihood of payment completion by assigning values to each piece of information, including the information of bill 100, and the user's payment history, as well as possibly other payment history of other users of the system and received payment history of the payee. Cloud 150 may determine a score for all the data, which represents a statistical valuation of the data. The score is then compared to a threshold to determine if it is more or less likely for payment to be completed. The system may determine that the user is more likely to pay if a discount is applied to the total bill, so a possible determined payment option may be the total with a % discount applied for a one-time payment. The user has selected and paid multiple times in the past when a discount was provided. Discounts may be predetermined set or variable amounts, determined by the application in real-time, or a set amount agreed to by the payee. In another possible outcome, the payor may not have a lot of money at the moments, so smaller payments near pay day may have a greater likelihood of payment when the user has the funds and the payments are not as large. The user may not pay bills around holidays, so the system determines that payments are less likely to be completed at this time, and more transactions are occurring on credit cards at merchants, indicating gift buying or vacations, so the user is less likely to pay other invoices as they may be financially distracted.

Cloud 150 may determine all the possible payment options for the user and send those that qualify, or are greater than the threshold, back to computing device 140 for computing device 140 to determine a display of the resulting information at a GUI for viewing by the user. In some embodiments, one option may be displayed, or in other embodiments and were determined by the system, more than one possible payment options may be displayed at the GUI. One payment may have a discount applied to a one-time payment in full (displaying the discounted amount and showing the discount that was applied to the total due 102), and the other options may have 6 installments payments of $52.39. The user may select the installment payments. The user has already agreed to pay the 6 different payments of $52.39.

In some embodiments, the payment options may also allow the user to edit the payment options displayed. The user may change the installment frequency or amount per each installment. The application will then update the options with the edited information and allow the user to continue with the revised option(s), allowing the user to select the edited installment or other payment option.

Once a payment option is selected, the application may then update the GUI output of computing device 140 with the selected payment option, displaying the option selected, and determining at least one way to make the transaction. Electronic payment applications, such as PayPal, Google Pay, Zelle, Apple Pay, credit cards, etc, may be displayed for the user's selection. The user may then select the payment method and execute the payment based on the selected payment option.

In some embodiments, the application may send the users selection to cloud 150 to update the stored data for using the selection information for future use of the application, by the user and other users. Edited payment information entered by the user may also store in association with the session information. The determined payment options that were part of the GUI output may also be stored as well in association with the session information and outcome selection. Payment method selection may also be saved in association with the session.

Different embodiments of computing device 140 (and remote servers of the system, such as cloud 150) may vary. Computing device 140 (or cloud 150) may store information related to operation of the respective one of the operational modules. Storage devices, in some examples, have the primary purpose of being short term and not long-term computer-readable storage mediums. Storage devices on computing device may be configured for short-term storage of information as volatile memory and therefore not retain stored contents if powered off. Examples of volatile memories include random access memories (RAM), dynamic random-access memories (DRAM), static random-access memories (SRAM), and other forms of volatile memories known in the art. Storage devices may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage devices may store program instructions and/or data associated with user interface module, receiver module, object identification module, image module, payment module, bill module, graphics module, machine learning (not in illustration), AI module (not in illustration), object recognition module, operating system, and applications (e.g., using one of user settings datastore, account datastore, terms datastore, graphics datastore, bill datastore, payment applications, other device input datastore, identifiers data store, medical records datastore, and patient info datastore, learning datastore, prediction datastore, AI datastore). One or more processors may implement functionality and/or execute instructions within computing device. For example, processors on computing device may read and execute instructions stored by storage devices that execute the functionality of user interface, object recognition module, camera module, receiver module, output devices and communication, operating system, and other applications. These instructions executed by processors, at least one or more, may cause computing device to store information within storage devices during program execution, such as user settings, medical scanning, determine a first graphical element, determine identifiers, prioritizes data based on values for data and identifiers, receive data from payors devices, determine input and payment from other users of the system, determine a second graphical element, and learn by updating and using predictions techniques.

Computing device 140 may use the hardware components and modules, for identifying information in bill 100 by using object recognition software analyzing bill 100 when the application takes a photo, video, or otherwise receives or executes for bill 100. Other applications, of the plurality of applications on computing device 140, may execute to have an electronic form of bill 100 for the application to begin execution of the billing program.

Computing device 140 may contain a storage device 30 may include a volatile or non-volatile computer readable storage medium that is able to store such as software programs and data to implement the functionality of the lane determination system. In some examples, storage device(s), as described, may include non-volatile storage elements, such as magnetic hard discs, optical discs, floppy discs, flash memories, or forms of electrically programmable memories (EPROM) or electrically erasable and programmable (EEPROM) memories. For example, storage device(s) 48 may include Random Access Memory (RAM), Read Only Memory (ROM), flash memory or any other form of long term or short-term memory, although without limitation thereto. In some embodiments, the memory may also include hard disk drive, floppy disk drive, tape drive, secure digital (SD) card, digital versatile disc random access memories (DVD-RAM), or any other appropriate form of computer readable storage medium. Processor(s) may be operably connected to a communication unit(s), an input device(s) for receiving using input or received input from other parts of the system, an output device(s) that sent data to other parts of the system, a user interface (UI) device may include a presence-sensitive screen where the user may input data by interacting with the screen. Processor(s) may include, but not limited to, microprocessor unit, graphical processor unit, digital signal processor or any other appropriate processors that have the capability to execute computer program instructions on data to produce the expected output. A processor(s), not shown in FIG. 1, may include a plurality of components from a list including registers, buffers, control logic, data lines, arithmetic logic unit (ALU), floating-point unit (FPU), and other appropriate components for performing operations including arithmetic, logical, control, input, and output specified by the instructions in a computer program.

Computing device 140 may also include hardware and/or software modules including antenna to communicate wirelessly to the Internet, a camera device to capture photo and video, capture audio, a call module, short message service (SMS) module, a media player module to play multimedia content (for example: music and movie), and an Internet web browser (for example: Firefox and Google Chrome), and billing module and payment module. Computing device 140 may also have additional applications installed such as VPN network access, billing records, payment information, calculator, calendar, text editor, camera, screen shot, and other appropriate application programs. Billing module may execute instructions that include program instructions stored in memory within the storage device(s), stored externally, or transmitted by means of radio waves or electromagnetic waves. The application or components of the system may retrieve device data from storage device(s), which is a data store for computing device 140.

Further, the application, such as billing (option) module may automatically determine a possible billing option or multiple options. Billing module may cause processors to connect to appropriate storage devices to retrieve and store data.

In some examples, a probability may be a value in a range between 0-1. In some examples, a probability may be initialized to a value of 0.5. Once identification module 62 locates user preferences, indicator module 66 may compare the determined data with the characteristics of the condition's indicators. Based on the comparisons, indicator module 66 may determine the probability based on a comparison of probabilities determined for previously identified indicators, stored in a data storage (e.g., user selection, user history, other users, payee history, financial status, date, calendar, payee identification, total due, bill type, etc.). The indicators and the associated weighted probabilities may then be sent to cloud 150 or locally for billing module to determining predicted likelihood of making the payment and payee receiving full or partial payment. In some examples, only certain values or scores may be sent to condition module 68. For example, applying a threshold value to determine which indicators to select and send to condition module 68 for further condition analysis.

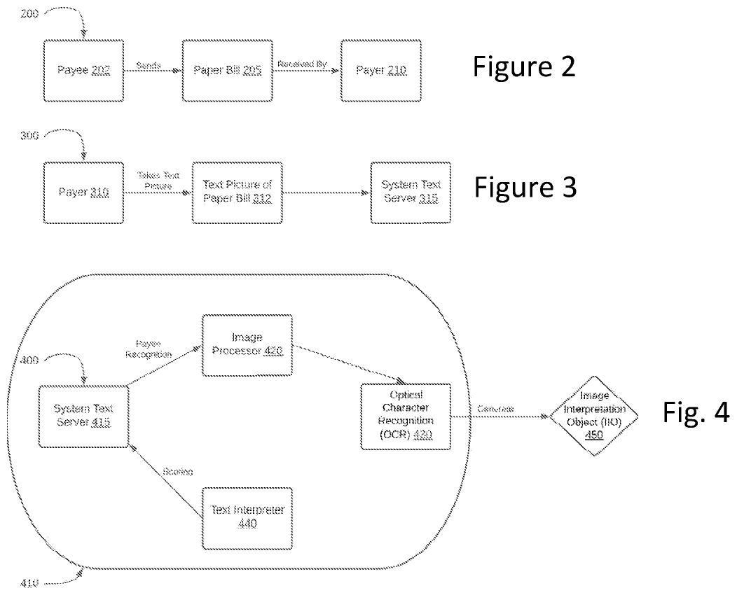

FIGS. 2 and 3 are schematic diagrams of a portion of an embodiment that illustrates the structure of the disclosed system and method. In FIG. 2 scheme 200, payee 202 sends paper bill 205 that is received by payer 210. Then, as shown in scheme 300, payer 310 takes and sends text picture 312 of paper bill 205 to system text server 315.

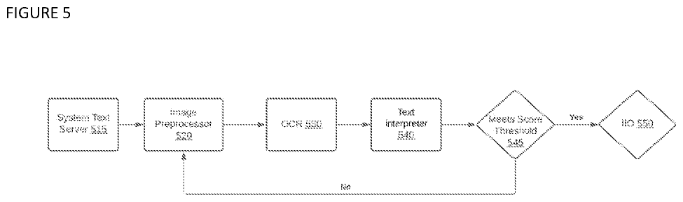

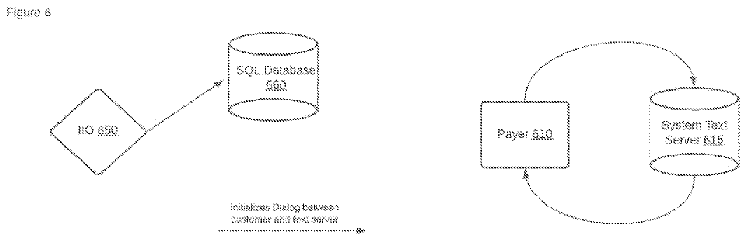

FIG. 4 is a schematic diagram of a portion of an embodiment of the disclosed system and method in which the text image is interpreted. Schematic 400 shows image preprocessor 410. Preprocessor 410 includes system text server 415 that uses image processor 420 to recognize the payee. Image processor 420 can preform cropping, grey scale, Gaussian blur, or other functions on the text image to make it readable by Optical Character Recognition (OCR) 430. The image then goes through text interpreter 440 that pulls out the payment amount, detects the identification of the payee, and extracts any other needed text information such as names, addresses, e-mail addresses, text addresses, etc. that are on the paper bill. Text interpreter 440 also calculates a score that rates the accuracy of the information that has been extracted. The disclosed system has a predetermined threshold score that sets a minimum score that needs to be attained in order to have the image be accurate enough so that the system can operate with minimal errors. If the threshold score is not attained, the image is recycled through image processer 420 until the image meets the threshold score. If the threshold score is not attained within a predetermined number of trials, then a new image is requested from the payer. Then the image is used to generate an Image Interpretation Object (110) 450.

FIG. 5 is a schematic diagram of a portion of an embodiment of the disclosed system and method that how the text is continuously processed and reprocessed until a threshold score is attained. FIG. 5 shows more detail for the recycling of the image through the image preprocessor until a threshold score is attained. System text server 515 passes a text picture stored within it to image preprocessor 520. Image preprocessor 520 then uses techniques such as cropping, gray scaling, or Gaussian blurring to name a few to improve the contrast of the text picture so that it can be read by Optical Character Recognition 530. Text interpreter 540 then ranks the quality of the image that has been preprocessed and gives it a score. If the score meets a preset threshold of the system, then it generates an image in Image Interpretation Object 550. If the score does not meet the threshold score, the image is recycled to image preprocessor 520 for more refinement until the threshold score is met.

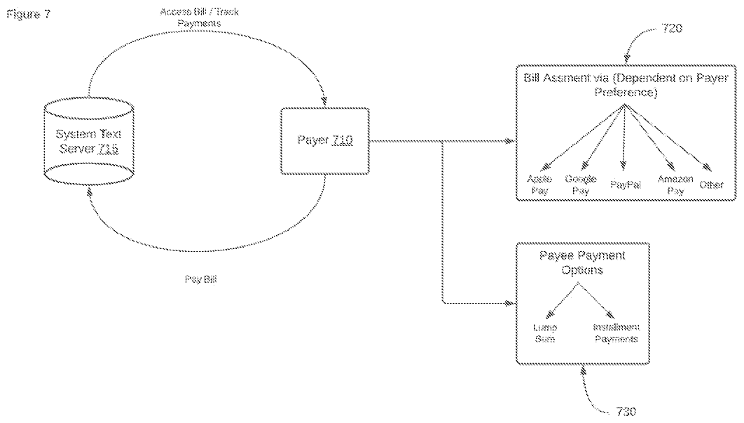

FIG. 6 is a schematic diagram of a portion of an embodiment of the disclosed system and method that illustrates the interaction of the image interpretation object with the SQL server and the system text server. As shown in FIG. 6, Image Interpretation Object 660 sends the stored processed image to SQL database 660 for storage. Additionally, Image Interpretation Object 660 initializes a dialog between the payer (customer) 610 and system text server 615.

FIG. 7 is a schematic diagram of a portion of an embodiment of the disclosed system and method that illustrates the interaction of the system text server with the payer and payment options offered to the payer. FIG. 7 shows system text server 715 assesses the bill and tracks the payment to payer 710. Subsequently, payer 710 pays the bill through system text server 715. Payer 715 then chooses a platform such as PAY PAL, APPLE PAY, GOOGLE PAY, any preferred electronic platform for payment 720. Additionally, payer 715 sends payee payment options 730 such as a lump sum or installment payments.

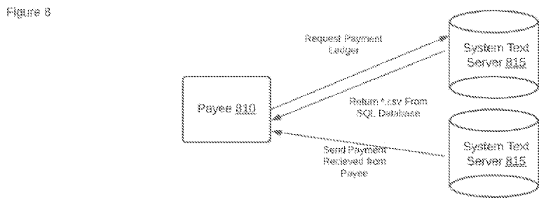

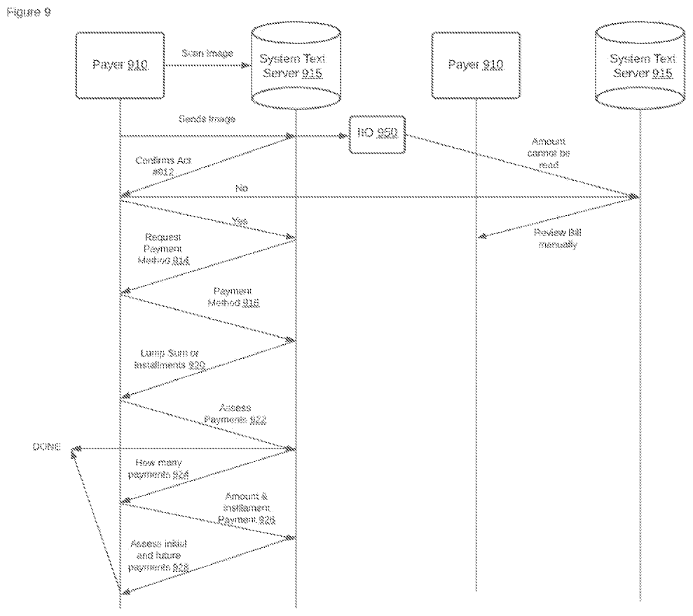

FIG. 8 is a schematic diagram of a portion of an embodiment of the disclosed system and method that illustrates the information flow between the payee and the system text server. Payee 810 requests a payment ledger to system text server 815. Text server 815 then returns a payment ledger from the SQL database. System text server 815 then sends the payment received from the payer to payee 810.

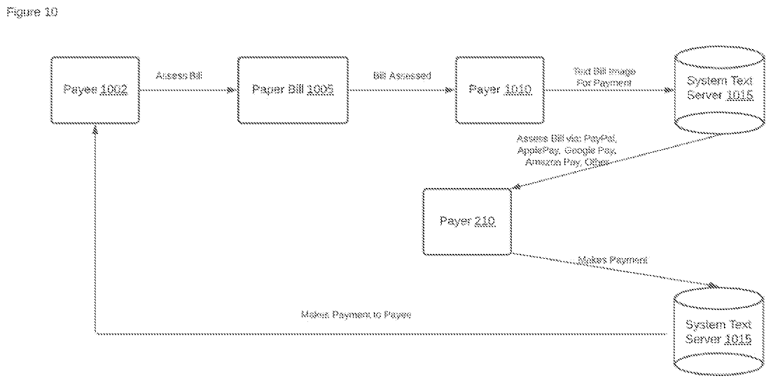

FIG. 9 is a schematic diagram of a portion of an embodiment of the disclosed system and method that illustrates the dialog flow between the payee, payer, and system text server. Payee 910 scans the paper bill to system text server 915. System text server 915 communicates back and forth with payer according to the flow shown in FIG. 9. After the paper bill is scanned, text server 915 confirms the account number 912. If the account number is not confirmed, then a message is sent directly to system text server 915 that the transaction is invalid. If the account is confirmed, then system text server 915 requests the desired payment method 914. Desired payment method 914 selected by payer 910 is sent to system text server 915 and can be a lump sum payment or an installment payment. System text server 915 then asks payer 910 if it will be a lump sum or an installment payment 920. If a lump sum payment is desired, then the payment is assessed 922 and the communication is complete and done. If installment payments are chosen system text server 915 then queries payer 910 how many payments are desired 924. The choices may be chosen from options preset by the disclosed system. Typically, four installment payments may be suggested although that number can be greater or lesser. Once the amount of an installment is determined 926, then system text server 915 assesses the payment 928 and schedules and informs payer 910 of the amount and timing for further installment payments. The disclosed system then sends out reminders or automatically withdraws installment payments (using the same electronic method selected earlier for payment) at the scheduled intervals.

FIG. 10 is a schematic diagram of an overall view of an embodiment of the disclosed system and method. Schematic 1000 shows payee 1002 sending paper bill 1005 to payer 1010 who then text paper bill 1005 to system text server 1015. System text server 1015 assesses paper bill 1005 via a selected electronic platform and then communicates with payer 1010. Payer 1010 then makes payment to system text server 1015 which then sends the payment to payee 1002. This is all done electronically.

Another system, such as FIG. 11 of the related and priority provisional 63/087,152, may be an entity relationship an embodiment of the disclosed system and method that outlines how the information will be stored within the SQL database about a payer/payee relationship. It provides a skeleton of the information that we are looking to collect and the relationships between entities that will exist. The diamond shapers are “Relationships” while the squares are “entities”. The circles in FIG. 11 are “attributes” of an entity. The payer can have one or many relationships with Images. Images can have a one-to-one relationship with each bill as each bill will be processed into a bill object. User can make multiple payments to a bill thus it participates in a many to one relationship with payment. A bill can receive multiple payments creating a one bill to many payments' relationship. User can only request one payment plan and consequently the User and Payment plan have a one-to-one relationship. Payment plan may include multiple schedules payments such that one payment to many scheduled payments relationship exists.

While embodiments of the invention have been illustrated and described, it will also be apparent that various modifications can be made without departing from the scope of the invention. It is also contemplated that various combinations or sub combinations of the specific features and aspects of the disclosed embodiments can be combined with or substituted for one another in order to form varying modes of the invention. Accordingly, it is not intended that the invention be limited, except as by the appended claims. All references cited within are herein incorporated by reference in their entirety.

A brief review of the disclosure is an application for paying bills that is executable on a computing device, wherein the computing device includes at least one processor, the at least one processor for executing the following receiving a bill, wherein the bill has an amount due and information associated with a payee, when executing one application of a plurality of applications on the computing device. The application may further include sending, by the computing device, a request for at least one payment option and receiving, by the computing device, the at least one payment option, which are based at least in part on the amount due and on a likelihood that the user will pay. The application may output, at the graphical user interface, the at least one payment option, and the application may receive, at a graphical user interface of the computing device, a user input associated with a selection of one of the respective at least one payment option. The graphical user interface may include an output, based on the user selection input, of an indication of at least one service for paying the payee.

In some embodiments, the application may send the payment option selection is stored in association with the likelihood of completed payment. The application may determine an amount due by the user is based at least partially on at least one of the total amount(s) due, a discount, a number of installment payments, an amount of each installment payment, objects on the bill, payee, payment history of the user, the date, geography, description in the bill, the amount of time to pay, frequency of payment, the type of bill, use of the application, and other payment history associated with other users. In some embodiments, the at least one payment option is based on object recognition of the send request. Payment options may be determined by applying a value to the objects of the sent request, associated user, and payment information to determine a value, which can be compared to a threshold associated with a likelihood of user fulfilling payment.

In some embodiments, the output allows the user to confirm the determine information associated with the bill. The application may receive input from the user associated with a full payment or an installment payment. The application may display the installment payment, based on the user information and the payee, and at least one payment option for the user to pay the bill. Sending the request may cause the computing device to output information received in response to the sent request, indicating agreeing to terms and conditions or verifying previously agreed to terms and conditions. The application sends the user input to a remote server to update the likelihood that the user will pay at least a portion of the amount due.

The bill may include an indication associated with instructions for initiating payment of the bill. The application may receive an input by the user at the graphical user interface that modifies the payment option display, and may store the user input in association with an updated likelihood of payment completion and paying the number of payments.

Another embodiment of the disclosure is a system for paying bills that comprises executed on a computing device, wherein the computing device includes at least one processor, the at least one processor for executing the following receiving, from the computing device, a request for at least one payment option for paying a bill, wherein the bill has an indicated amount due and is associated with an executed application of a plurality of applications on the computing device, and determining, based on the received request and the bill, at least one payment option associated with a likelihood that the user will pay the at least one payment option. The system may send, to the computing device, the at least one payment option for paying at least a portion of the bill. The system may further receive, from the computing device, a selection by the user of the at least one payment option and store the selection by the user in association with the likelihood of preferred payments of the user and the likelihood that the user will pay the payment options.

The system may further receive request includes payee information comprising at least one of an amount due, a due date, an account number, and identification of the payer. The bill received is one of a photo of a bill, a screen shot of the bill, an account notice of the bill and an electronic document, includes one or more images and text; further wherein the system includes the text interpreter is structured and configured to provide a score relating to the quality of the translated pixels of information stored in the system text server. The system for paying bills according to claim 11, further comprises interpreting one or more images, by object and character recognition software; and storing interpreted information in associating with the likelihood that the user will pay. The received bill may be at least one of an image, which contains object, of the bill, upload the bill document, take a screen shot of the bill, account information, notification, text, email, scannable code, voice message, message, and a document.

The system may further determine if the user has agreed to terms and conditions for using the application by verifying a telephone number or account number is associated with agreed to terms. The user may edit the payment due; and where changed payment input by the user input is stored in association with the user and the system updates likelihood of user preferences for payment based on the input. The system for paying bills, wherein the computing device stores only the selection information for use with machine learning but does not store confidential user account information.

The system for paying bills may further comprise a payee recognition module that comprises: a system text server; an image preprocessor structured and configured to crop, gray scale, or Gaussian blur, wherein the text picture is stored in the system text server; an optical character recognition software structured and configured to translate pixels of information stored in the image preprocessor into text characters in the text picture; and a text interpreter that identifies the due date, the account number, identification of the payee, the amount due, and contact information for the payer from the text picture.

The system, as a summary, may be applied for paying bills, wherein the application receives in put form the user to confirm the bill information related to a value and an identification of the bill. The bill is at least one of, electronic communication, a screen shot, document, QR code, and recorded message. The system for paying bills wherein the computing device stores only the selection information for use with machine learning but does not store confidential user account information.

The system for paying bills may store only the selection information for use with machine learning and payment information that is protected against cyber security breaches, and stores the received bill. The system for paying bills wherein the determining an amount to be paid by the user is based on the number of installment payments and the total amount due. The system for paying bills may communicate with a remote server. A system for paying bills wherein a payee recognition module that comprises: a system text server; an image preprocessor structured and configured to crop, gray scale, or Gaussian blur, wherein the text picture is stored in the system text server, an optical character recognition software structured and configured to translate pixels of information stored in the image preprocessor into text characters in the text picture, and a text interpreter that identifies the due date, the account number, identification of the payee, the amount due, and contact information for the payer from the text picture.

A system for paying bills wherein the text interpreter is structured and configured to provide a score relating to the quality of the translated pixels of information stored in the system text server. A system for paying bills further comprising an image interpretation object structured and configured structured and configured to store information. A system for paying bills wherein the bills are for a medical or dental payee. The system for paying bills allows the user to edit the payment due; and where changed payment input by the user input is stored in association with the user and the system updates likelihood of user preferences for payment based on the input.

In another embodiment of the invention, a method of paying bills may comprise receiving a bill, wherein the bill has an amount due and information associated with a payee, when executing one application of a plurality of applications on the computing device, sending, by the computing device, a request for at least one payment option, and receiving, by the computing device, the at least one payment option, which are based at least in part on the amount due and on a likelihood that the user will pay. The method may further include outputting, at the graphical user interface, the at least one payment option, receiving, at a graphical user interface of the computing device, a user input associated with a selection of one of the respective at least one payment option; and outputting, at the graphical user interface and based on the user selection input, an indication of at least one service for paying the payee.

The method of claim 20, further comprising a payee sending a bill to a payer, wherein the bill comprises a statement that includes instructions to the payer, and the payer sending an image of the bill. The method may further include sending the image of the bill to a billing text number disposed upon the bill, wherein the image of the bill includes one or more objects and text, wherein the one or more objects is processed by an interpretive object reader, and wherein the text payee information is processed by optical character recognition software.

A method of paying bills may also comprise a payee sending a bill to a payer, wherein the bill comprises a statement that includes instructions to the payer disposed upon it; the payer taking a text picture of the bill and sending the text picture of the bill to a billing text number disposed upon the bill, wherein the text picture of the bill includes one or more images and text; wherein the one or more images is processed by an image interpretive object, and wherein the text payee information is processed by optical character recognition software.

What is claimed is:

1. An application for paying bills that is executable on a computing device, wherein the computing device includes at least one processor, the at least one processor for executing the following:
receiving a bill, wherein the bill has an amount due and information associated with a payee, when executing one application of a plurality of applications on the computing device;
sending, by the computing device, a request for at least one payment option;
receiving, by the computing device, the at least one payment option, which are based at least in part on the amount due and on a likelihood that the user will pay;
outputting, at the graphical user interface, the at least one payment option;
receiving, at a graphical user interface of the computing device, a user input associated with a selection of one of the respective at least one payment option; and
outputting, at the graphical user interface and based on the user selection input, an indication of at least one service for paying the payee.

2. The application of claim 1, wherein sending the payment option selection is stored in association with the likelihood of completed payment.

3. The application of claim 1, wherein determining an amount due by the user is based at least partially on at least one of the total amount due, a discount, a number of installment payments, an amount of each installment payment, objects on the bill, payee, payment history of the user, the date, geography, description in the bill, the amount of time to pay, frequency of payment, the type of bill, use of the application, and other payment history associated with other users.

4. The application of claim 1, wherein the at least one payment option is based on object recognition of the send request; further wherein payment options are determined by applying a value to the objects of the sent request, associated user, and payment information to determine a value, which can be compared to a threshold associated with a likelihood of user fulfilling payment.

5. The application of claim 1, wherein the output allows the user to confirm the determine information associated with the bill;
receiving input from the user associated with a full payment or an installment payment; and
displaying the installment payment, based on the user information and the payee, and at least one payment option for the user to pay the bill.

6. The application of claim 1, wherein sending the request causes the computing device to output information received in response to the sent request, indicating agreeing to terms and conditions or verifying previously agreed to terms and conditions.

7. The application the application of claim 1, wherein the application sends the user input to a remote server to update the likelihood that the user will pay at least a portion of the amount due.

8. The application the application of claim 1, wherein the bill includes an indication associated with instructions for initiating payment of the bill.

10. The application the application of claim 1, further comprises receiving an input by the user at the graphical user interface that modifies the payment option display; and storing the user input in association with an updated likelihood of payment completion and paying the number of payments.

11. A system for paying bills that comprises executed on a computing device, wherein the computing device includes at least one processor, the at least one processor for executing the following:
receiving, from the computing device, a request for at least one payment option for paying a bill, wherein the bill has an indicated amount due and is associated with an executed application of a plurality of applications on the computing device;
determining, based on the received request and the bill, at least one payment option associated with a likelihood that the user will pay the at least one payment option;
sending, to the computing device, the at least one payment option for paying at least a portion of the bill; and
receiving, from the computing device, a selection by the user of the at least one payment option; and
storing the selection by the user in association with the likelihood of preferred payments of the user and the likelihood that the user will pay the payment options.

12. The system for paying bills according to claim 11, wherein the received request includes payee information comprising at least one of an amount due, a due date, an account number, and identification of the payer.

13. The system for paying bills according to claim 11, wherein the bill received is one of a photo of a bill, a screen shot of the bill, an account notice of the bill and an electronic document, includes one or more images and text; further wherein the system includes the text interpreter is structured and configured to provide a score relating to the quality of the translated pixels of information stored in the system text server.

14. The system for paying bills according to claim 11, further comprises interpreting one or more images, by object and character recognition software; and storing interpreted information in associating with the likelihood that the user will pay.

15. The system for paying bills according to claim 11, wherein the received bill may be at least one of an image, which contains object, of the bill, upload the bill document, take a screen shot of the bill, account information, notification, text, email, scannable code, voice message, message, and a document.

16. The system for paying bills according to claim 11, wherein the system determines if the user has agreed to terms and conditions for using the application by verifying a telephone number or account number is associated with agreed to terms.

17. The system for paying bills according to claim 11, wherein the application further allows user to edit the payment due; and where changed payment input by the user input is stored in association with the user and the system updates likelihood of user preferences for payment based on the input.

18. The system for paying bills according to claim 1, wherein the computing device stores only the selection information for use with machine learning but does not store confidential user account information.

19. A system for paying bills according to claim 1, wherein the application further comprises a payee recognition module that comprises:
a system text server;
an image preprocessor structured and configured to crop, gray scale, or Gaussian blur,
wherein the text picture is stored in the system text server;
an optical character recognition software structured and configured to translate pixels of information stored in the image preprocessor into text characters in the text picture; and
a text interpreter that identifies the due date, the account number, identification of the payee, the amount due, and contact information for the payer from the text picture.

20. A method of paying bills comprising:
receiving a bill, wherein the bill has an amount due and information associated with a payee, when executing one application of a plurality of applications on the computing device;
sending, by the computing device, a request for at least one payment option;
receiving, by the computing device, the at least one payment option, which are based at least in part on the amount due and on a likelihood that the user will pay;
outputting, at the graphical user interface, the at least one payment option;
receiving, at a graphical user interface of the computing device, a user input associated with a selection of one of the respective at least one payment option; and
outputting, at the graphical user interface and based on the user selection input, an indication of at least one service for paying the payee.

21. The method of claim 20, further comprising:
a payee sending a bill to a payer,
wherein the bill comprises a statement that includes instructions to the payer;
the payer sending an image of the bill; and
sending the image of the bill to a billing text number disposed upon the bill,
wherein the image of the bill includes one or more objects and text;
wherein the one or more objects is processed by an interpretive object reader, and
wherein the text payee information is processed by optical character recognition software.
